(19) United States
(12) Patent Application Publication
(10) Pub. No.: US 2015/0332640 A1
(43) Pub. Date: Nov. 19, 2015

(54) LIQUID CRYSTAL DISPLAY AND METHOD FOR CONTROLLING IMAGING OF THE SAME

(71) Applicant: Shenzhen China Star Optoelectronics Technology Co., Ltd., Shenzhen, Guangdong (CN)

(72) Inventors: Zuomin Liao, Shenzhen (CN); Bing Han, Shenzhen (CN)

(21) Appl. No.: 14/378,321

(22) PCT Filed: May 19, 2014
(86) PCT No.: PCT/CN2014/077770

§ 371 Date: Aug. 12, 2014

(51) Int. Cl. G09G 3/36; H04N 13/04

(52) U.S. Cl. CPC G09G 3/3607; H04N 13/0422; H04N 13/0454; G09G 2320/10; G09G 2330/023; G09G 2300/0452; G09G 2300/0478

(57) ABSTRACT

The present invention provides a liquid crystal display comprising a display unit, wherein the display unit is capable of working in a first display mode and a second display mode, each pixel of the display unit includes a red sub-pixel, a green sub-pixel, a blue sub-pixel, and a white sub-pixel; the display unit drives the red sub-pixel, green sub-pixel, blue sub-pixel, and white sub-pixel to emit light in the first display mode, and drives the red sub-pixel, green sub-pixel, and blue sub-pixel to emit flight without driving the white sub-pixel to emit light in the second display mode. The present invention further provides a method for controlling imaging of the liquid crystal display.

### BACKGROUND

1. Technical Field

The present invention generally relates to technologies of liquid displays, and more particularly, to a liquid crystal display and a method for controlling imaging of the liquid crystal display.

2. Description of Related Art

With the development of the liquid crystal technology, the requirement of the market for properties of a liquid crystal display including a resolution and an energy consumption level of the liquid crystal display becomes higher and higher. In order to reduce the power consumption, at present, in the typical 2D display mode, a color W (white) is integrated into three original colors R (red), G (green), B (blue) of a pixel to increase an overall transmittance of the liquid crystal display. Since the W sub-pixel does not include a color filter, light absorption caused by the color filter of the W sub-pixel is reduced, thus, a backlight module can meet the imaging requirement of the display with lower light intensity, thereby reducing the power consumption of the liquid crystal display.

However, at present, most of the liquid crystal displays have additional 3D display functions, in which the display typically uses the film-type patterned retarder (FPR) technology to realize a 3D effect. During the process of realizing the 3D effect, a broader light blocking region is required for preventing the crosstalk between left-eye images and right-eye images. At present, a pixel display region is used as a dark light blocking region for preventing the crosstalk between left-eye images and right-eye images, which reduces the translucent area of the liquid crystal display, causes the backlight module to emit brighter light with higher power to meet the imaging requirements of the display, increase the power consumption of the liquid crystal display with higher power, increases the production cost, and reduces the competiveness of the product.

It should be noted that the above description is only used for facilitating the understanding of the technical solution of the present invention and is not treated as an acknowledgement that the above description is the prior art.

### SUMMARY

The main object of the present invention is to provide a liquid crystal display and a method for controlling imaging of the liquid crystal display, aiming at solving the problem that the power consumption and production cost of a 3D liquid crystal display in a RGBW mode are high.

A liquid crystal display is provided herein for realizing the above object, including a display unit, wherein the display unit is capable of working in a first display mode and a second display mode, each pixel of the display unit includes a red sub-pixel, a green sub-pixel, a blue sub-pixel, and a white sub-pixel; the display unit drives the red sub-pixel, green sub-pixel, blue sub-pixel, and white sub-pixel in the first display mode, and drives the red sub-pixel, green sub-pixel, and blue sub-pixel without driving the white sub-pixel in the second display mode.

Preferably, the first display mode is a 2D display mode, and the second display mode is a 3D display mode.

Preferably, the red sub-pixel, green sub-pixel, and blue sub-pixel are parallel to each other, and the white sub-pixel is perpendicular to the red sub-pixel, green sub-pixel, and blue sub-pixel without intersecting with the red sub-pixel, green sub-pixel, and blue sub-pixel.

Preferably, the red sub-pixel, green sub-pixel, blue sub-pixel, and white sub-pixel are parallel to each other.

Preferably, the white sub-pixel is vertically or horizontally arranged.

The present invention further provides a method for controlling imaging of the above liquid crystal display, including the following steps:
when the liquid crystal display is in the first display mode, controlling the display unit to drive the red sub-pixel, green sub-pixel, blue sub-pixel, and white sub-pixel to emit light; and
when the liquid crystal display is in the second display mode, controlling the display unit to drive the red sub-pixel, green sub-pixel, and blue sub-pixel to emit light without driving the white sub-pixel to emit light.

The display unit set in the present invention is capable of working in the first display mode and the second display mode, each pixel of the display mode includes a red sub-pixel, a green sub-pixel, a blue sub-pixel, and a white sub-pixel; the liquid crystal display controls the display unit to drive the red sub-pixel, green sub-pixel, blue sub-pixel, and white sub-pixel to emit light in the first display mode (for example, 2D display mode), which increases the light transmittance of the display unit, reduces the requirement for the intensity of the backlight of the liquid crystal display, and thus reduces the power consumption of the liquid crystal display; the liquid crystal display controls the display unit to drive the red sub-pixel, green sub-pixel, and blue sub-pixel to emit light without driving the white sub-pixel to emit light in the second display mode (for example, 3D display mode), thus, the white sub-pixel forms a dark opaque region which can be used as a light blocking region when the liquid crystal display uses the FPR technology to realize the 3D effect, thereby preventing the crosstalk between left-eye images and right-eye images. In this way, it need not stop driving the red, green, and blue sub-pixels to emit light and use the region of the red, green, and blue sub-pixels as the dark light blocking region, which avoids an oversized transparent region of the liquid crystal display and thereby prevents the light transmittance of the display unit from getting too low, therefore, the requirement of the intensity of the backlight of the liquid crystal display and the power consumption of the liquid crystal display can both be reduced. In this way, no matter whether the liquid crystal display works in the first display mode (for example, 2D display mode) or the second display mode (for example, 3D display mode), the liquid crystal display has a lower power consumption and an enhanced market competiveness.

### DESCRIPTION OF THE DRAWINGS

Many aspects of the embodiments can be better understood with reference to the following drawings. The components in the drawings are not necessarily dawns to scale, the emphasis instead being placed upon clearly illustrating the principles of the embodiments. Moreover, in the drawings, like reference numerals designate corresponding parts throughout the several views.

FIG. 1 is a schematic view showing how a color gamut of a display unit is divided in accordance with a first embodiment of the present invention;

FIG. 2 is a schematic view showing how a color gamut of a display unit is divided in accordance with a second embodiment of the present invention;

FIG. 3 is a schematic view showing how a color gamut of a display unit is divided in accordance with a third embodiment of the present invention; and

FIG. 4 is a schematic view showing how a color gamut of a display unit is divided in accordance with a fourth embodiment of the present invention.

### DETAILED DESCRIPTION

It should be understood that the specific embodiment described herein is only for explaining the present invention and is not intended to limit the present invention.

The present invention provides a liquid crystal display having a display unit which can work in a first display mode and a second display mode. Each pixel of the display unit includes a red sub-pixel, a green sub-pixel, a blue sub-pixel, and a white sub-pixel. In the first display mode, the display unit drives the red, green, blue, and white sub-pixels to emit light; in the second display mode, the display unit drives the red, blue, and white sub-pixels to emit light without driving the white sub-pixel to emit light.

In an embodiment, the display unit of the liquid crystal display can work in the first display mode and the second display mode. Each pixel of the display unit includes a red sub-pixel, a green sub-pixel, a blue sub-pixel, and a white sub-pixel. In the first display mode (for example, 2D display mode), the liquid crystal display controls the display unit to drive the red, green, blue, and white sub-pixels to emit light, which improves a light transmittance of the display unit, reduces the requirement for the intensity of the backlight of the liquid crystal display, and thus reduces the power consumption of the liquid crystal display. In the second display mode (for example, 3D display mode), the liquid crystal display controls the display unit to drive the red, green, and blue sub-pixels to emit light without driving the white sub-pixel to emit light, therefore, the white sub-pixel forms a dark opaque region which is used as a light blocking region of the liquid crystal display when the liquid crystal display uses the FPR technology to realize the 3D effect, thereby preventing the crosstalk between left-eye images and right-eye images. In this way, it need not stop driving the red, green, and blue sub-pixels to emit light and use the display region of the red, green, and blue sub-pixels as the light blocking region, which avoids an oversized transparent region of the liquid crystal display and thereby prevents the light transmittance of the display unit from getting too low, therefore, the requirement of the intensity of the backlight of the liquid crystal display and the power consumption of the liquid crystal display can both be reduced. In this way, no matter whether the liquid crystal display works in the first display mode (for example, 2D display mode) or the second display mode (for example, 3D display mode), the liquid crystal display has a lower power consumption and an enhanced market competiveness.

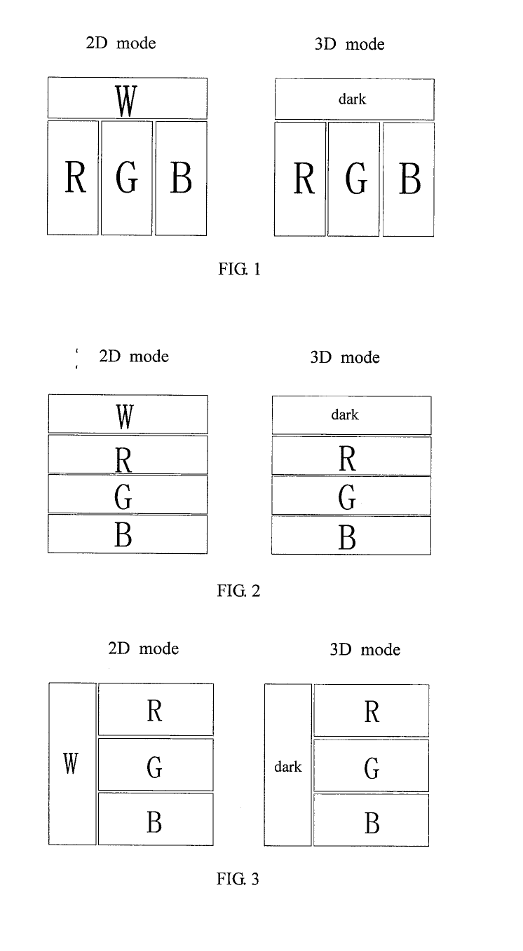

Furthermore, referring to FIGS. 1 and 3, the red, green, and blue sub-pixels are parallel to each other, and the white sub-pixel is respectively perpendicular to the red, green, and blue sub-pixels without intersecting with the red, green, and blue sub-pixels. The white sub-pixels are vertically or horizontally arranged. In the embodiment of the present invention, W stands for the white sub-pixel, R stands for the red sub-pixel, G stands for the green sub-pixel, and B stands for the blue sub-pixel. The left sides of FIGS. 1 and 3 show the displaying state of the pixel in the first display mode of the liquid crystal display, in which the display unit drives the red, green, blue, and white sub-pixels to emit light. The right sub-figures of FIGS. 1 and 3 respectively show the displaying state of the corresponding pixel in the second display mode (for example, 3D display mode) of the display unit, in which the display unit drives the red, green, and blue sub-pixels to emit light without driving the white sub-pixel to emit light, making the white sub-pixel in a dark state and become the light blocking region used for preventing the crosstalk between left-eye images and right-eye images. In this way, no additional light blocking region is required to avoid the decline of the light transmittance of the display unit, that is, to reduce the requirement of the intensity of the backlight of the liquid crystal display and the power consumption of the liquid crystal display.

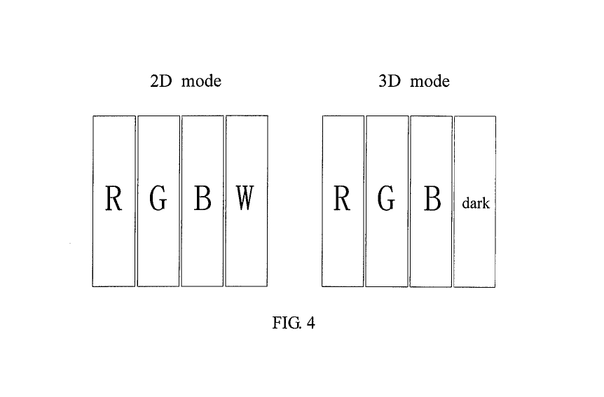

Similarly, FIGS. 2 and 4 show the red, green, blue, and white sub-pixels are parallel to each other, and the white sub-pixel is perpendicularly or horizontally arranged.

The present invention further provides a method for controlling imaging of the above liquid crystal display, includes the following steps:
when the liquid crystal display is in the first display mode, controlling the display unit to drive the red, green, blue, and white sub-pixels to emit light;
when the liquid crystal display is in the second display mode, controlling the display unit to drive the red, green, and blue sub-pixels to emit light without driving the white sub-pixel to emit light.

Even though information and the advantages of the present embodiments have been set forth in the foregoing description, together with details of the mechanisms and functions of the present embodiments, the disclosure is illustrative only; and that changes may be made in detail, especially in matters of shape, size, and arrangement of parts within the principles of the present embodiments to the full extend indicated by the broad general meaning of the terms in which the appended claims are expressed.

1. A liquid crystal display comprising a display unit, wherein the display unit is capable of working in a first display mode and a second display mode, each pixel of the display unit comprises a red sub-pixel, a green sub-pixel, a blue sub-pixel, and a white sub-pixel; the display unit drives the red sub-pixel, green sub-pixel, blue sub-pixel, and white sub-pixel to emit light in the first display mode, and drives the red sub-pixel, green sub-pixel, and blue sub-pixel to emit light without driving the white sub-pixel to emit light in the second display mode.

2. The liquid crystal display of claim 1, wherein the first display mode is a 2D display mode, and the second display mode is a 3D display mode.

3. The liquid crystal display of claim 2, wherein the red sub-pixel, green sub-pixel, and blue sub-pixel are parallel to each other, and the white sub-pixel is perpendicular to the red sub-pixel, green sub-pixel, and blue sub-pixel without intersecting with the red sub-pixel, green sub-pixel, and blue sub-pixel.

4. The liquid crystal display of claim 2, wherein the red sub-pixel, green sub-pixel, blue sub-pixel, and white sub-pixel are parallel to each other.

5. The liquid crystal display of claim 3, wherein the white sub-pixel is vertically or horizontally arranged.

6. The liquid crystal display of claim 4, wherein the white sub-pixel is vertically or horizontally arranged.

7. The liquid crystal display of claim 1, herein the red sub-pixel, green sub-pixel, and blue sub-pixel are parallel to each other, and the white sub-pixel is perpendicular to the red sub-pixel, green sub-pixel, and blue sub-pixel without intersecting with the red sub-pixel, green sub-pixel, and blue sub-pixel.

8. The liquid crystal display of claim I wherein the red sub-pixel, green sub-pixel, blue sub-pixel, and white sub-pixel are parallel to each other.

9. The liquid crystal display of claim 7, wherein the white sub-pixel is vertically or horizontally arranged.

10. The liquid crystal display of claim S. wherein the white sub-pixel is vertically or horizontally arranged.

11. A method for controlling imaging of the liquid crystal display of claim 1, comprising the following steps:
when the liquid crystal display is in the first display mode, controlling the display unit to drive the red sub-pixel, green sub-pixel, blue sub-pixel, and white sub-pixel to emit light; and
when the liquid crystal display is in the second display mode, controlling the display unit to drive the red sub-pixel, green sub-pixel, and blue sub-pixel to emit light without driving the white sub-pixel to emit light.

12-20. (canceled)

21. The method of claim 11, wherein the first display mode is a 2D display mode, and the second display mode is a 3D display mode.

22. The method of claim 21, wherein the red sub-pixel, green sub-pixel, and blue sub-pixel are parallel to each other, and the white sub-pixel is perpendicular to the red sub-pixel, green sub-pixel, and blue sub-pixel without intersecting with the red sub-pixel, green sub-pixel, and blue sub-pixel.

23. The method of claim 21, wherein the red sub-pixel, green sub-pixel, blue sub-pixel, and white sub-pixel are parallel to each other.

24. The method of claim 22, wherein the white sub-pixel is vertically or horizontally arranged.

25. The method of claim 23, wherein the white sub-pixel is vertically or horizontally arranged.

26. The method of claim 11, wherein the red sub-pixel, green sub-pixel, and blue sub-pixel are parallel to each other, and the white sub-pixel is perpendicular to the red sub-pixel, green sub-pixel, and blue sub-pixel without intersecting with the red sub-pixel, green sub-pixel, and blue sub-pixel.

27. The method of claim 11, wherein the red sub-pixel, green sub-pixel, blue sub-pixel, and white sub-pixel are parallel to each other.

28. The method of claim 26, wherein the white sub-pixel is vertically or horizontally arranged.

29. The method of claim 27, wherein the white sub-pixel is vertically or horizontally arranged.
